(19) United States
(12) Patent Application Publication
(10) Pub. No.: US 2009/0134768 A1
(43) Pub. Date: May 28, 2009

(54) ELECTRON EMISSION DEVICE, METHOD OF MANUFACTURING THE SAME, AND ELECTRON EMISSION DISPLAY INCLUDING THE SAME

(76) Inventors: Young-Chul Choi, Suwon-si (KR); Jong-Hwan Park, Suwon-si (KR)

Correspondence Address: CHRISTIE, PARKER & HALE, LLP, PO BOX 7068, PASADENA, CA, 91109-7068, US

(21) Appl. No.: 12/325,038

(22) Filed: Nov. 28, 2008

(30) Foreign Application Priority Data
Nov. 27, 2007 (KR) 10-2007-0121475

(51) Int. Cl. H01J 1/62; H01J 1/13; H01J 9/00

(52) U.S. Cl. 313/483; 313/310; 445/58

(57) ABSTRACT

An electron emission device includes: a substrate; a cathode on the substrate; one or more electron emission regions electrically connected with the cathode; an insulation layer between the cathode and a gate electrode formed on the insulation layer; and a resistance layer electrically connected to the cathode and the one or more electron emission regions. Here, the resistance layer includes a boron nitride-based material.

### CROSS-REFERENCE TO RELATED APPLICATION

This application claims priority to and the benefit of Korean Patent Application No. 10-2007-0121475, filed in the Korean Intellectual Property Office on Nov. 27, 2007, the entire content of which is incorporated herein by reference.

### BACKGROUND OF THE INVENTION

1. Field of the Invention

The present invention relates to an electron emission device, a method of manufacturing the same, and an electron emission display including the same.

2. Description of the Related Art

An electron emission display can include an electron emission device formed with an array of electron emission members, including a plurality of electron emission regions, on a first substrate. The electron emission device is coupled with a second substrate, mounted with a light emitting device (or light emitting unit) composed of a phosphor layer, an anode, etc., to form an electron emission display.

A plurality of first electrodes are electrically connected to the electron emission regions and are for supplying an electric current required for emitting electrons. The first electrodes can be separated into either a main electrode applied with a driving voltage or an isolation electrode disposed with the electron emission regions. A resistance layer is formed between the main electrode and the isolation electrode at both sides of the isolation electrode. The resistance layer is separately formed to provide uniform resistance to each isolation electrode.

As such, a separate resistance is formed between the main electrode and the isolation electrode at every electron emission region. The emitted current of the electron emission regions is controlled due to the resistance layer to improve the emission uniformity per unit pixel.

Conventionally, such a resistance layer does not provide for a stable performance at a high temperature. Therefore, it is difficult to maintain a suitable resistivity level for a finally fabricated electron emission device because the performance of the device is deteriorated during the fabrication of the electron emission device under a high temperature environment.

### SUMMARY OF THE INVENTION

Aspects of embodiments of the present invention are directed toward an electron emission device capable of maintaining a uniform resistance level at a high temperature, a method of manufacturing the same, and an electron emission display including the same.

An aspect of an embodiment of the present invention is directed toward an electron emission device including a resistance layer capable of maintaining a uniform resistance level at a high temperature due to its high thermal stability at the high temperature.

Another aspect of an embodiment of the present invention is directed toward a method of manufacturing the electron emission device in which a resistance layer can be fabricated with a simplified process.

A further aspect of an embodiment of the present invention is directed toward an electron emission display including the electron emission device capable of maintaining the uniform resistance level at the high temperature.

Aspects of embodiments of the present invention are not limited to the above technical purposes, and aspects of embodiments of the present invention can have other technical purposes.

In an embodiment of the present invention, an electron emission device includes: a substrate; a cathode on the substrate; one or more electron emission regions electrically connected with the cathode; a gate electrode; and an insulation layer between the cathode and the gate electrode, the gate electrode being on the insulation layer; and a resistance layer electrically connected to the cathode and the one or more electron emission regions. Here, the resistance layer includes a boron nitride-based material.

In another embodiment of the present invention, a method of manufacturing an electron emission device includes: forming a cathode on a substrate; forming an insulation layer on the cathode; forming a gate electrode on the insulation layer; partially etching the insulation layer to form a hole; coating a paste including a boron nitride material inside the hole to form a resistance layer; and providing an electron emission region on one side of the resistance layer.

A further embodiment of the present invention includes an electron emission display including the above electron emission device.

Hereinafter, further embodiments of the present invention will be described in more detail.

The electron emission device and the electron emission display including the same according to embodiments of the present invention can increase (or maximize) the effect of light emitting uniformity at a high temperature firing process while fabricating the electron emission display because the resistivity of the resistance layer is relatively constant due to the boron nitride material in the resistance layer.

In addition, the method of fabricating the resistance layer may be simplified due to the simple structure of the resistance layer.

### BRIEF DESCRIPTION OF THE DRAWINGS

FIG. 1 is a partial magnified cross-sectional schematic view showing an electron emission display according to an embodiment of the present invention.

FIG. 2 is a partial top plan schematic view showing cathodes and electron emission regions of the electron emission display shown in FIG. 1.

FIG. 3 is a partial top plan schematic view showing a portion of a first substrate of the electron emission display shown in FIG. 1.

FIG. 4 is a partial cross-sectional schematic view of an electron emission display according to another embodiment of the present invention.

FIG. 5 is a partial cross-sectional schematic view of an electron emission display according to a further embodiment of the present invention.

FIG. 6 is a partial cross-sectional schematic view of a conventional electron emission display.

FIG. 7 is a graph showing resistivity changes according to ambient temperatures of the resistance layers according to Example 1 and Comparative Example 1.

### DETAILED DESCRIPTION OF THE EMBODIMENTS

In the following detailed description, only certain exemplary embodiments of the present invention are shown and described, by way of illustration. As those skilled in the art would recognize, the invention may be embodied in many different forms and should not be construed as being limited to the embodiments set forth herein. Also, in the context of the present application, when an element is referred to as being “on” another element, it can be directly on the another element or be indirectly on the another element with one or more intervening elements interposed therebetween. Like reference numerals designate like elements throughout the specification.

The present invention will be described more fully hereinafter with reference to the accompanying drawings, in which exemplary embodiments of the invention are shown. Embodiments of the present invention may have various suitable shapes and are not limited to the embodiments shown.

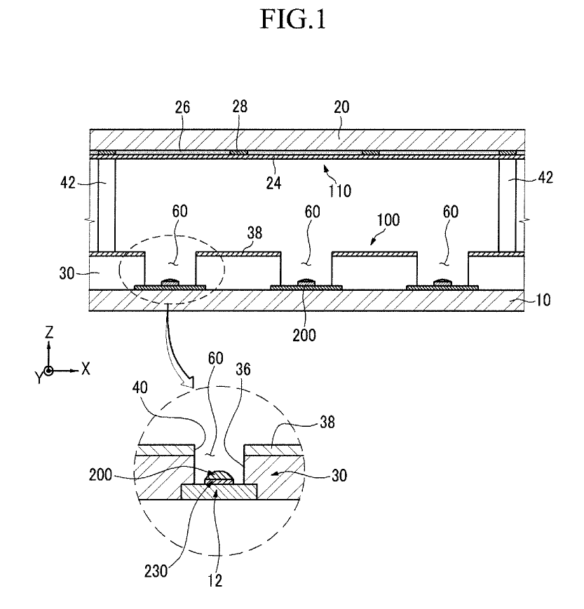

FIG. 1 is a partial magnified cross-sectional schematic view showing an electron emission display according to an embodiment of the present invention.

Referring to FIG. 1, the electron emission display includes a first substrate 10 and a second substrate 20 arranged to face each other with a distance therebetween. The first substrate 10 and the second substrate 20 are coupled to each other with a sealing member on boundaries (or periphery portions) thereof to form a container having an internal space. The container is evacuated under about 10⁻⁶ Torr to form the container as a vacuum vessel (or vacuum container) composed of the first substrate 10, the second substrate 20, and the sealing member.

On the surface of the first substrate 10 facing (or opposing) the second substrate 20, an array of electron emission members are provided to form an electron emission device 100. The electron emission device 100 is coupled with the second substrate 20, mounted with a light emitting device (or light emitting unit) 110 on the second substrate, to form an electron emission display.

Cathodes 12 are formed on the first substrate 10 in a stripe pattern along a first direction (Y-axis direction in FIG. 1) of the first substrate 10. Electron emission regions 200 are disposed in a set position on each of the cathodes 12.

An insulation layer 30 covers portions of the cathodes 12 and has one or more openings 36 for exposing the electron emission regions 200. Gate electrodes 38 are formed on the insulation layer 30 in a second direction (X-axis direction in FIG. 1) crossing (or perpendicular) to the first direction of the cathodes 12 in a stripe pattern. The gate electrodes 38 also have one or more openings 40 corresponding in position(s) to the one or more openings 36 of the insulation layer 30.

According to one embodiment of the present invention, a crossing (or cross-over) region of one cathode 12 and one gate electrode 38 is referred to as a pixel region. The insulation layer 30 can have one opening 36 in every pixel region, and at least one electron emission region 200 is formed on the cathode 12 in the opening 36.

In addition, a resistance layer 230 including a boron nitride material is formed inside a hole 60, and the resistance layer 230 may be disposed on an upper side of the cathode 12 and under the electron emission region 200 (or disposed between the cathode 12 and the electron emission region 200).

The light emitting unit 110 includes red, green, and blue phosphor layers 26 along the first (or length) direction (Y-axis direction in FIG. 1) on a surface of the second substrate 20 facing (or opposing) the first substrate 10, and black layers 28 are formed between the phosphor layers 26 to increase the contrast of the display. In addition, an anode 24 is formed to cover the phosphor layers 26 and the black layers 28.

According to this embodiment, the anode 24 includes a metal thin film such as aluminum so that it is possible to ensure high voltage-resistance characteristics even when a high voltage of 5 kV or more is applied, thereby increasing luminance of the display due to a metal back effect of the metal thin film.

Further, in another embodiment, the anode may include a transparent conductive layer (and not the metal thin film as described above). For example, the anode may include indium tin oxide (ITO). In this embodiment, the anode is formed on the second substrate, and the phosphor layers and the black layers are formed on the anode.

The electron emission regions 200 include materials for emitting electrons when a voltage is applied therewith under a vacuum, for example a carbon-based material and/or a nano-sized material. In one embodiment, the electron emission regions 200 are formed by carbon-based materials such as carbon nanotubes (CNT), graphite, graphite nanofiber, diamond, diamond-like carbon (DLC), fullerene (C₆₀), etc., and/or by nano-sized materials such as silicon nanowire. Alternatively, the electron emission regions 200 include ends having a sharp tip structure and that are composed of molybdenum (Mo) and/or silicon (Si).

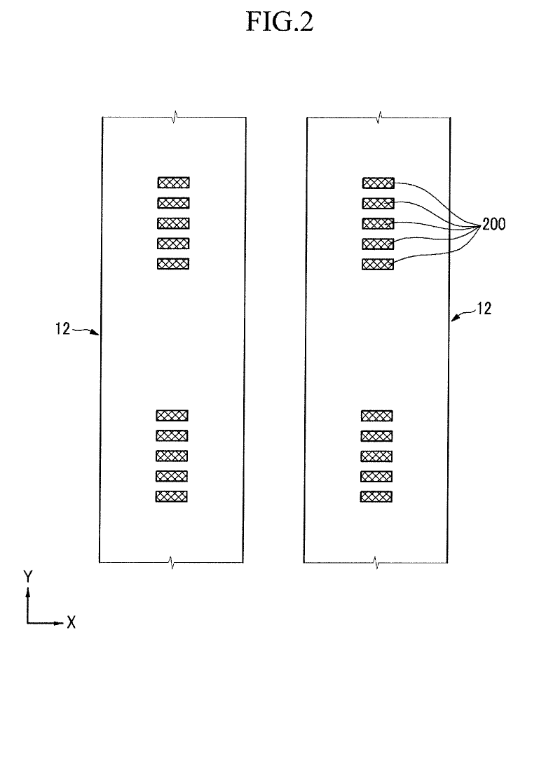

FIG. 2 is a partial plan schematic view showing the cathodes and electron emission regions of the electron emission display shown in FIG. 1. As shown in FIG. 2, the cathodes 12 may be formed in a stripe pattern, and a plurality of electron emission regions 200 (and resistance layers including boron nitride positioned under the electron emission regions 200) are formed on the cathode 12 in every pixel region.

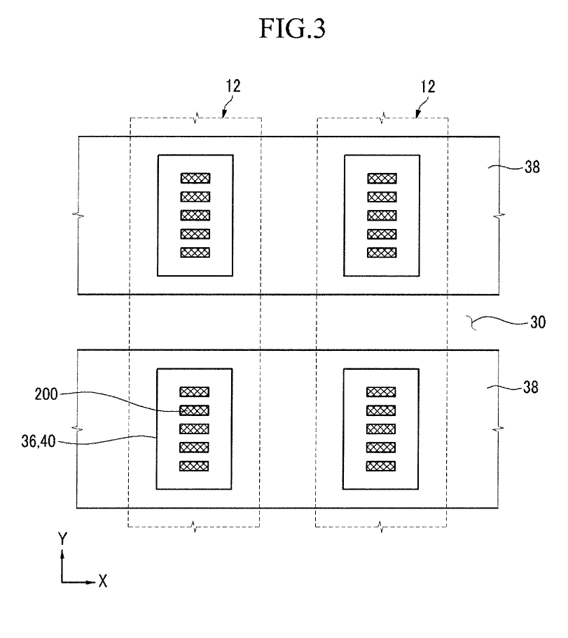

FIG. 3 is a partial top plan schematic view showing a portion of the first substrate of the electron emission display shown in FIG. 1.

As shown in FIG. 3, the cathode 12 and the gate electrode 38 are disposed to cross each other. In addition, a plurality of electron emission regions 200 and resistance layers including boron nitride positioned under the electron emission regions 200 are shown to be disposed on the cathode 12 in the opening 36 of the insulation layer 30 and an opening 40 of the gate electrode 38.

According to one embodiment, the electron emission regions 200 are formed into a rectangular shape and arranged in series along the first direction (or length direction Y) of the cathode 12. However, this may be altered in various suitable manners without limiting the shape, the number per pixel area, and an arranged form of the electron emission regions 200.

The resistance layer 230 electrically connecting cathode 12 and electron emission region 200 is interposed therebetween. The resistance layer 230 includes a boron nitride material.

For example, the boron nitride material may have various suitable shapes such as of nanotubes, nanowire, powder, nanorods, etc., and the boron nitride material having the above shapes may be used in a mixture.

The resistance layer 230 may be formed using a paste including the boron nitride material. The paste including the boron nitride material can simplify a manufacturing process of the resistance layer.

In another embodiment, the resistance layer 230 may be formed using a paste including a boron nitride material having a nanotube shape. The boron nitride material having a nanotube shape can improve connection therebetween in the paste. A method of preparing the paste will be described in more detail below.

As a resistivity increment ratio according to temperature is reduced, the resistance layer shows better properties. The resistance layer may have a resistivity increment ratio of 1% per 1° C. of a firing temperature, and in one embodiment, it has a resistivity increment ratio of 0.5%. In one embodiment, when the resistivity increment ratio is more than 1%, the resistance increment ratio may increase too much during a firing process at a high temperature, and the resultant device performance may be deteriorated. As the resistivity increment ratio is reduced, the electron emission display may be stable even with a firing process at a high temperature, and the resultant light emitting uniformity of a display may be improved.

Further, a plurality of spacers 42 are disposed between the first 10 and second substrates 10 and 20 in the non-pixel area in order to uniformly maintain the gap therebetween.

The electron emission display is driven by supplying a certain voltage to the cathode 12, the gate electrode 38, and the anode 24. For example, the cathode 12 is applied with 0V, the gate electrode 38 is applied with a voltage between several tens and several hundred volt (+), and the anode 24 is applied with a voltage between several hundred and several thousand volt (+).

Thereby, the electrostatic field is formed around the electron emission regions 200 due to the voltage differentiation between the cathode 12 and the gate electrode 38 to emit the electrons. The emitted electrons form electron beams to be introduced and collided with the phosphor layer 26 of the corresponding pixel due to the high voltage applied to the anode 24, and thus lights are emitted by the phosphor layer 26 to display an image (or predetermined image).

In the present embodiment, the resistance layer 230 is disposed on the cathode 12 and under the electron emission region 200, but the position of the resistance layer is not limited thereto.

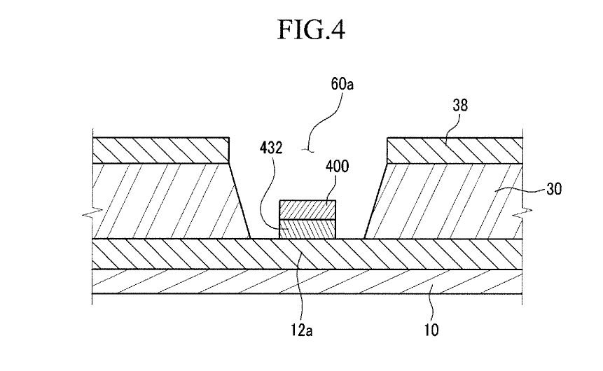

As shown in FIG. 4, a resistance layer 432 including the boron nitride material inside a hole 60a may be disposed between a cathode 12a and an electron emission region 400 having an upper plane surface. The cathode 12a is disposed to contact one side of the insulation layer 30 on an entire surface of the first substrate 10.

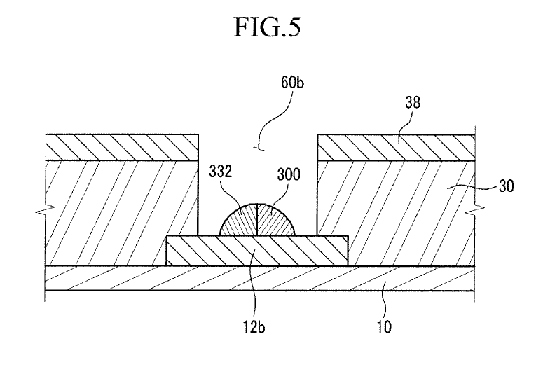

As shown in FIG. 5, a resistance layer 332 including a boron nitride material is formed in a hole 60b and on a cathode 12b. In addition, the resistance layer 332 may be formed at a place contacting one surface of an electron emission region 300 on the cathode 12b. Here, the resistance layer 332 is located beside the electron emission region 300 on the cathode 12b.

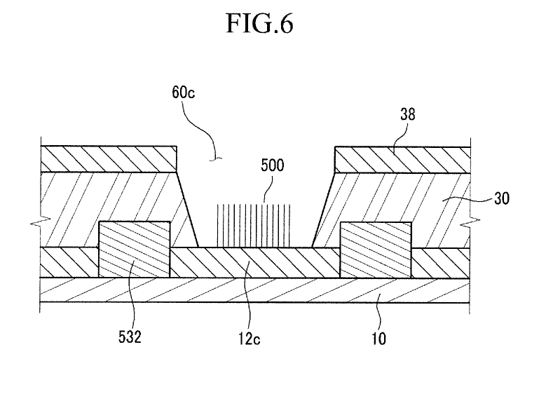

FIG. 6 is a partial cross-sectional view of a conventional electron emission display mounted with a resistance layer 532 and an electron emission region 500. As shown in FIG. 6, the conventional resistance layer 532 includes amorphous silicon (a-Si). The conventional resistance layer 532 including the amorphous silicon has a form of a thin film and a lateral structure that is formed on the substrate 10, which is different from embodiments of the present invention in that the resistance layer is not exposed by (or not formed on the inside of) a hole 60b, so that it is considerably more complex to manufacture.

Accordingly, embodiments of the present invention have merits in that the resistance layer can be manufactured in a more simplified method. Also, the embodiments can improve the performance of the resistance layer because the resistance is formed by using the paste including the boron nitride material, and/or the resistance layer is disposed under the electron emission region.

Hereinafter, a method of manufacturing an electron emission device according to an embodiment of the present invention will be described in more detail below. The described manufacturing method is only one embodiment, and the present invention is not limited to this method.

Initially, a process for preparing a paste for a resistance layer including a boron nitride material and a paste for an electron emission region will be described in more detail. As used hereinafter, the paste including the boron nitride material is referred to as a resistance layer paste.

The resistance layer paste may be prepared by mixing boron nitride materials having various suitable shapes of boron nanotubes, nanowire, powder, and/or nanorods; and a vehicle.

The vehicle is for controlling printability and viscosity of the paste, and includes a resin component and a solvent component.

In one embodiment, the resin component includes at least one resin component including cellulose-based resins (such as ethyl cellulose, nitrocellulose, etc.); acryl-based resins (such as polyester acrylate, epoxy acrylate, and urethane acrylate); and vinyl-based resins (such as polyvinyl acetate, polyvinyl butyral, polyvinyl ether, etc.), or combinations thereof. Some of the above-described resin components can also be a photosensitive resin.

In one embodiment, the solvent component includes at least one solvent component includes terpineol, butyl carbitol (BC), butyl carbitol acetate (BCA), toluene, texanol, or combinations thereof. In one embodiment, the solvent component includes terpineol.

When the amount of the solvent component is excessively large or small, the printability and flowability of the resistance layer paste may be deteriorated. Particularly, an excessively large amount of the vehicle increases drying time.

The resistance layer paste may further include a photosensitive resin and a photoinitiator as needed, and optionally a filler.

Non-limiting examples of the photosensitive resin include acrylate-based monomers, benzophenone-based monomers, acetophenone-based monomers, and thioxanthone-based monomers. More specific examples of the photosensitive resin include epoxy acrylate, polyester acrylate, 2,4-diethyloxanthone, and 2,2-dimethoxy-2-phenylacetophenone.

The photoinitiator cross-links the photosensitive resin upon exposure of the photosensitive resin. Non-limiting examples of the photoinitiator includes benzophenone, etc.

The filler improves conductivity and includes Ag, Al, Pd, etc.

The electron emission region paste may be prepared by mixing electron-emitting materials by voltage application under vacuum, such as a carbon-based material and/or a nano-sized material; and a vehicle. The vehicle is the same (or substantially the same) as described above.

The electron emission region paste may further include a photosensitive resin and a photoinitiator as needed, and optionally a filler. The photosensitive resin, photoinitiator, and filler are the same (or substantially the same) as described above.

The carbon-based material and/or the nano-sized material may include carbon nanotubes (CNT), graphite, graphite nanofiber, diamond, diamond-like carbon (DLC), fullerene (C₆₀), silicon nanowire, or combinations thereof. Alternatively, the electron emission region paste may include molybdenum (Mo) and/or silicon (Si). The nano-sized material is a material having a particle size (or diameter) between several nm and several hundred nm.

The cathodes are formed on the first substrate, the insulation layer is disposed between the cathodes, and the gate electrodes are successively deposited on the insulation layer.

Subsequently, the mask pattern is formed on the gate electrode with a set thickness. The mask pattern is formed to provide a hole of the gate electrode, and it can be obtained by a photolithography process including coating a photoresist (PR) and forming a pattern using UV and/or an E-beam.

Using the mask pattern, the gate electrodes and the insulation layer are etched to provide hole(s) of the gate electrodes. The etching process may be carried out by wet etching that uses an etching solution, dry etching that uses a corrosive gas, and/or micro-machining that uses ion beams, depending upon the materials and the thickness of the gate electrodes and insulation layer.

The obtained paste for the resistance layer is coated on the inside of holes to provide a resistance layer pattern. After exposing the resistance layer pattern, it is subjected to a developing process. The coating process may be carried out by screen printing and/or table coating.

After forming the resistance layer pattern, a firing process may be further included. The firing process is carried out at a temperature between 350° C. and 500° C. under a mixed gas atmosphere of oxygen and nitrogen. The amount of oxygen in the mixed gas of oxygen and nitrogen is 1000 ppm or less, and in another embodiment, the amount of oxygen in the mixed gas of oxygen and nitrogen is between 10 ppm and 500 ppm.

On the obtained resistance layer pattern, the paste for an electron emission region is coated to provide an electron emission region pattern on the mask pattern. The coating process is carried out as in the above.

On the other hand, when the paste for an electron emission region includes a photosensitive resin, a photoresist is coated through photolithography and is selectively irradiated to provide an electron emission region pattern.

The resistance layer pattern and the electron emission region pattern are subjected to the firing process under oxygen gas and/or a mixed gas atmosphere of oxygen and nitrogen. When the electron emission region pattern is formed without the firing process after the resistance layer pattern is formed, the electron emission region pattern is also fired by the firing process together with the resistance layer pattern to provide a resistance layer and an electron emission region.

The amount of oxygen in the mixed gas of oxygen and nitrogen is 1000 ppm or less, and in another embodiment, the amount of oxygen in the mixed gas of oxygen and nitrogen is between 10 ppm and 500 ppm. The vehicle can be volatilized and removed by the firing process under the oxidizing gas atmosphere. The vehicle can improve the adherence between the resistance layer and electron emission region and the substrate. The vehicle can also improve the durability of the electron emission region.

The firing temperature should be determined by considering the volatilizing temperature and time of the vehicle included in the paste for the resistance layer and the paste for the electron emission region. In one embodiment, the general firing temperature is between 350° C. and 500° C. In one embodiment, when the firing temperature is less than 350° C., it may cause problems in that the volatilization is insufficient. In another embodiment, when the firing temperature is more than 500° C., it may also cause problems in that the manufacturing cost is increased, and the substrate is damaged.

The resulting fired material (resistance layer and electron emission region) may be subjected to an activating step, if required. According to one embodiment, in the activating step, the resulting fired material is coated with a surface treatment agent for an electron emission region including a solution that is capable of being cured into a film through heat treatment, for example a polyimide polymer, and is heated and peeled off the heated substrate. According to another exemplary embodiment, the activating process can be carried out by providing the adherent region having an adhering strength on a roller surface that is driven by a set driving source, and pressing the resulting fired material surface with a set (or predetermined) pressure. In one embodiment, when the paste for an electron emission region includes the nano-sized material, the nano-sized material may be exposed to the surface of the electron emission region and/or controlled to be vertically oriented, through the activating process.

The present invention will be described in more detail with reference to the following examples. However, these examples are for illustrative purposes only and are not intended to limit the scope of the present invention.

### EXAMPLE 1

1 g of boron nitride nanotube (BNT) powder, 5 g of polyester acrylate, and 5 g of benzo phenone were added to 10 g of terpineol and agitated to provide a paste for a resistance layer (BNT paste).

Then, 1 g of carbon nanotube (CNT) powder and 0.2 g of frit (8000 L, manufactured by SHINHEUNG CERAMICS) were added to 10 g of terpineol and agitated to provide a paste for an electron emission region (CNT paste).

The obtained BNT paste was coated on a first substrate formed with a Cr gate electrode, an insulation layer, and an ITO electrode to form a photoresist pattern, and was exposed. The BNT paste was irradiated with an exposing energy of 500 mJ/cm² by a collimated exposer to provide a BNT pattern through a developing process. The CNT paste was coated on the obtained BNT pattern on a mask pattern by screen printing to provide an electron emission region pattern.

Then, the combination with the BNT pattern and the electron emission region pattern was fired at a temperature of 420° C. under nitrogen gas in the presence of 500 ppm oxygen to provide a resistance layer and an electron emission region. A second substrate mounted with a phosphor layer and an anode of ITO was disposed to face the first substrate mounted with the electron emission region, and spacers were provided between the first and second substrates to maintain the cell gap to provide an electron emission display.

### EXAMPLE 2

1 g of boron nitride nanotube (BNT) powder, 5 g of polyester acrylate, and 5 g of benzophenone were added to 10 g of terpineol and agitated to provide a BNT paste.

Then, 1 g of carbon nanotube (CNT) powder, 0.2 g of frit (8000L, manufactured by SHINHEUNG CERAMICS), 5 g of polyester acrylate, and 5 g of benzophenone were added to 10 g of terpineol and agitated to provide a CNT paste.

The obtained BNT paste was coated on a first substrate formed with a Cr gate electrode, an insulation layer, and an ITO electrode by a screen printing. The BNT paste was irradiated with an exposing energy of 500 mJ/cm² by a collimated exposer and developed to provide a BNT pattern. The CNT paste was coated on the obtained BNT pattern by screen printing and exposed with an exposing energy of 2000 mJ/cm² by a collimated exposer to provide an electron emission region pattern. Thereafter, the electron emission region pattern was developed with acetone and printed with a composition for an electron emission region (or electron emission source) on a region for forming the electron emission region, which is defined by a photoresist pattern. Then, the combination with the BNT pattern and the electron emission region pattern was fired at a temperature of 420° C. under nitrogen gas in the presence of 500 ppm of oxygen to provide a resistance layer and the electron emission region.

A second substrate mounted with a phosphor layer and an anode of ITO was disposed to face the first substrate mounted with the electron emission region, and spacers were provided between the first and second substrates to maintain the cell gap to provide an electron emission display.

### COMPARATIVE EXAMPLE 1

An electron emission display was fabricated in accordance with the same (or substantially the same) procedure as in Example 1, except that the resistance layer was composed of amorphous silicon (a-Si) instead of BNT.

### Measuring Resistivity Depending Upon Temperature

In order to measure the resistivity depending upon temperature, each of the pastes for a resistance layer obtained from Example 1 and Comparative Example 1 was coated to provide a resistance layer pattern. The resistance layer patterns were fired at a temperature of 420° C. to measure the resistivity (temperature of firing the resistance layers: 420° C.).

In order to provide similar conditions to those of the measurement atmosphere during the fabrication of the electron emission display, each resistance pattern that had been fired at a temperature of 420° C. was fired one more time at 420° C. to measure the resistivity (temperature of firing an electron emission region: 420° C.).

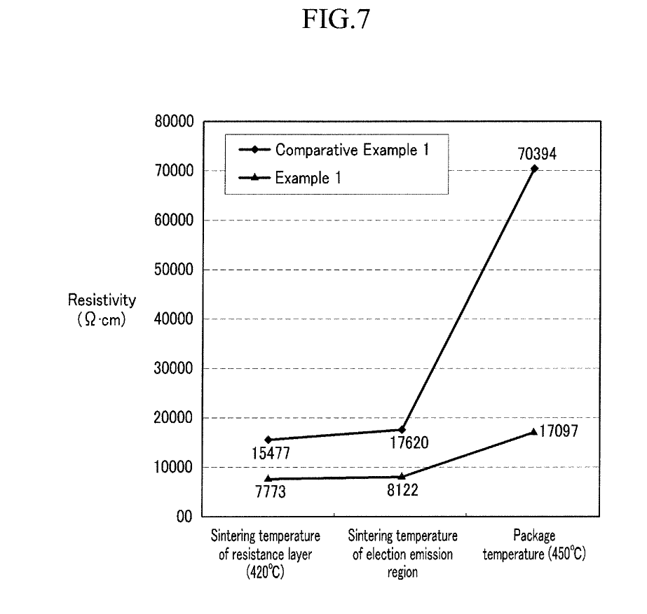

Furthermore, in order to provide similar conditions to the packaging conditions during the fabrication of the electron emission display, the paste for the resistance layer that had been fired at a temperature of 420° C. two times was fired at a temperature of 450° C. to measure the resistivity (packaging temperature: 450° C.). The resistivity results are shown in FIG. 7.

Referring to FIG. 7, it can be derived that the paste for a resistance layer paste including a-Si obtained from Comparative Example 1 has a dramatic increase in its resistivity depending upon the temperature of firing the resistance layer, the temperature of firing the electron emission region, and the packaging temperature. By contrast, it can be derived that the resistivity (7773 Ω·cm) at the early temperature for firing the resistance layer and the resistivity (17097 Ω·cm) at the packaging temperature of 450° C. is substantially constant (or has substantially not changed) in the paste for the resistance layer including BNT obtained from Example 1. As such, by utilizing an embodiment of the present invention, it is now possible to maintain constant resistivity while fabricating the electron emission display.

In view of the foregoing, it can be derived that the light emitting uniformity can be improved because the resistivity is not changed at a high temperature in the resistance layer including BNT as compared to that of the resistance layer including a-Si.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An electron emission device comprising:
a substrate;
a cathode on the substrate;
an electron emission region electrically connected with the cathode;
a gate electrode;
an insulation layer between the cathode and the gate electrode, the gate electrode being on the insulation layer; and
a resistance layer electrically connected to the cathode and the electron emission region,
wherein the resistance layer comprises a boron nitride-based material.

2. The electron emission device of claim 1, wherein the boron nitride material comprises boron nitride nanotubes, boron nitride nanowire, boron nitride powder, boron nitride nanorods, or combinations thereof.

3. The electron emission device of claim 1, wherein the resistance layer has a resistivity increment ratio of about 1% per about 1° C. of firing temperature.

4. The electron emission device of claim 1, wherein the resistance layer is on the cathode, and the electron emission region is on the resistance layer.

5. The electron emission device of claim 1, wherein the resistance layer is located beside the electron emission region on the cathode.

6. The electron emission device of claim 1, wherein the electron emission region comprises a material comprising a carbon-based material, a nano-sized material, or combinations thereof.

7. The electron emission device of claim 6, wherein the carbon-based material comprises carbon nanotubes (CNT), graphite, graphite nanofiber, diamond, diamond-like carbon (DLC), fullerene (C₆₀), or combinations thereof.

8. The electron emission device of claim 1, wherein the insulation layer has a hole for exposing a portion of the cathode, and both the resistance layer and the electron emission layer region are on the portion of the cathode.

9. A method of manufacturing an electron emission device, the method comprising:
forming a cathode on a substrate;
forming an insulation layer on the cathode;
forming a gate electrode on the insulation layer;
partially etching the insulation layer to form a hole;
coating a paste, comprising a boron nitride material, inside the hole to form a resistance layer; and
providing an electron emission region on one side of the resistance layer.

10. The method of claim 9, wherein the boron nitride material comprises boron nitride nanotubes, boron nitride nanowire, boron nitride powder, boron nitride nanorods, or combinations thereof.

11. The method of claim 9, wherein the resistance layer has a resistivity increment ratio of about 1% per about 1° C. of firing temperature.

12. The method of claim 9, wherein the resistance layer is formed by utilizing a paste comprising boron nitride nanotubes.

13. The method of claim 9, wherein the electron emission region comprises a carbon-based material, a nano-sized material, or combinations thereof.

14. The method of claim 13, wherein the carbon-based material comprises carbon nanotubes (CNT), graphite, graphite nanofiber, diamond, diamond-like carbon (DLC), fullerene (C₆₀), or combinations thereof.

15. The method of claim 9, wherein the resistance layer is formed by utilizing a method comprises screen printing, table coating, or combinations thereof.

16. An electron emission display comprising:
a first substrate;
a second substrate opposing the first substrate;
a phosphor layer on one surface of the second substrate facing the first substrate;
an anode on one surface of the phosphor layer; and
an electron emission device comprising:
a cathode on the first substrate,
an electron emission region electrically connected with the cathode,
a gate electrode,
an insulation layer between the cathode and the gate electrode, the gate electrode being on the insulation layer, and
a resistance layer electrically connected to the cathode and the electron emission region,
wherein the resistance layer comprises a boron nitride-based material.

17. The electron emission display of claim 16, wherein the boron nitride material comprises boron nitride nanotubes, boron nitride nanowire, boron nitride powder, boron nitride nanorods, or combinations thereof.

18. The electron emission display of claim 16, wherein the resistance layer has a resistivity increment ratio of about 1% per about 1° C. of firing temperature.

19. The electron emission device of claim 16, wherein the resistance layer is on the cathode, and the electron emission region is on the resistance layer.

20. The electron emission device of claim 16, wherein the resistance layer is located beside the electron emission region on the cathode.
